(19) United States
(12) Patent Application Publication
(10) Pub. No.: US 2007/0185822 A1
(43) Pub. Date: Aug. 9, 2007

(54) System and method for online third-party payment processing

(76) Inventors: Santosh Kaveti, Atlanta, GA (US); Dhanunjay Nadipalli, Norcross, GA (US); Phaneendra Vanka, Tucker, GA (US); Britton Calvert, Austell, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/647,538

(22) Filed: Dec. 28, 2006

Related U.S. Application Data
(60) Provisional application No. 60/754,593, filed on Dec. 28, 2005.

(51) Int. Cl. G06Q 99/00

(52) U.S. Cl. 705/78

(57) ABSTRACT

The present invention provides a system and method for a third party to process an online transaction of a first party on a computing device. In architecture, the system includes means for receiving an amount of the transaction from a first party and a means for processing the transaction. The system further includes a means for transmitting updated information regarding the transaction from the third-party to the first party and a second party. The present invention can also be viewed as a method for parsing itinerary data on a computing device. The method operates by (1) receiving an amount of the transaction from a first party; (2) processing the transaction; and (3) transmitting updated information regarding the transaction from the third-party to the first party and a second party.

### CROSS-REFERENCE TO RELATED APPLICATIONS

This application claims the benefit of U.S. Provisional Application Ser. No. 60/754,593, filed on Dec. 28, 2005, entitled “A System And Method For Online Third-Party Payment Processing” which is incorporated by reference herein in its entirety.

### TECHNICAL FIELD

The present invention relates to a method and system for processing E-payments, and more particularly, relates to a method and system for processing online E-payments by a third party.

### BACKGROUND OF THE INVENTION

Currently in the United States, most utilities, merchants and service providers have the ability to process transactions online (E-payment processing).

The problem for the E-payment processors is the cost of low-volume transaction traffic. These processors', who are often billing small amounts, must incur the cost of processing with each transaction. Given the economies of scale, a processor has a great incentive to reduce the cost of bill processing.

Therefore, there is a tremendous need for a third party processor to handle the payment processing of many low-volume traffic processors.

### SUMMARY OF THE INVENTION

The present invention provides for a method and system for processing E-payments, and more particularly, relates to a method and system for processing online E-payments by a third party. In architecture, the system includes a means for receiving an amount of the transaction from a first party and a means for processing the transaction. The system further includes a means for transmitting updated information regarding the transaction from the third-party to the first party and a second party.

The present invention can also be viewed as a method for parsing itinerary data on a computing device. The method operates by (1) receiving an amount of the transaction from a first party; (2) processing the transaction; and (3) transmitting updated information regarding the transaction from the third-party to the first party and a second party.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of the network environment for a service system utilizing the third-party payment system of the present invention.

FIG. 2A is a block diagram illustrating an example of a service device utilizing the third-party payment system of the present invention, as shown in FIG. 1.

FIG. 2B is a block diagram illustrating an example of functional elements in the vendor server that enables access to the third-party payment system of the present invention, as shown in FIG. 2A.

FIG. 3A is a flow chart illustrating an example of the operation of the vendor system of the present invention on the vendor server, as shown in FIGS. 1 and 2A.

FIG. 3B is a flow chart illustrating an example of the operation of the process transaction data process in the vendor system on the vendor server, as shown in FIGS. 1 and 2B.

FIG. 4 is a flow chart illustrating an example of the operation of the third-party payment system of the present invention, as shown in FIGS. 1 and 2A.

FIG. 5 is a flow chart illustrating an example of the operation of the process transaction process utilized by the third-party payment system of the present invention, as shown in FIGS. 2A and 4.

FIG. 6 is a flow chart illustrating an example of the operation of the send payment to vendor process utilized by the third-party payment system of the present invention, as shown in FIGS. 2A and 4.

FIG. 7 is a flow chart illustrating an example of the operation of the convenience fee check process utilized by the third-party payment system of the present invention, as shown in FIGS. 2A and 4-6.

FIG. 8A-8I are diagrams illustrating examples of the dialog boxes for a customer interacting with the third-party payment system of the present invention.

### DETAILED DESCRIPTION OF THE PREFERRED EMBODIMENTS

The present invention relates to a method and means for processing online E-payments by a third party. The third-party payment system of the present invention utilizes online communications to process payment transactions of utilities, merchants, service providers, and the like.

One example of third-party payment processing is the bill presentment & payment flow illustrated below. In this example, we assume the service being provided is utility services. However is contemplated by the inventors that other types of merchants or service providers can utilize the third party payment system of the present invention.

The process proceeds as follows.

(1) After the utility customer logs-in the utilities web site, customer is able to display one or all accounts, if there are multiple accounts for that customer.

(2) Now, if a customer from the account list display screen, selects a make payment button, then a notification dialog box appears informing the customer that they are being directed to a third party processor for processing the payments.

(3) After customer selects “Yes” for the redirection notification, Account, the CC and/or E-check profile info is packaged and redirected to an application hosted on SEDC domain. NOTE, the third party application launches in a new browser window. The URL for these pages will be third party processor address and not a merchant or service provider address.

(4) At the SEDC Web site, the customer decides the payment mode (Credit Card/E-check) and the amount to be paid on the application hosted on third party processor's domain. If customer closes dialogue box, they return to Account Selection screen.

(5) After submitting the credit card or E-check information, third party processor processes the transaction.

(6) Upon successful completion of the transaction, third party processor submits a response back to the utility application in order to update the customer account on the utilities database.

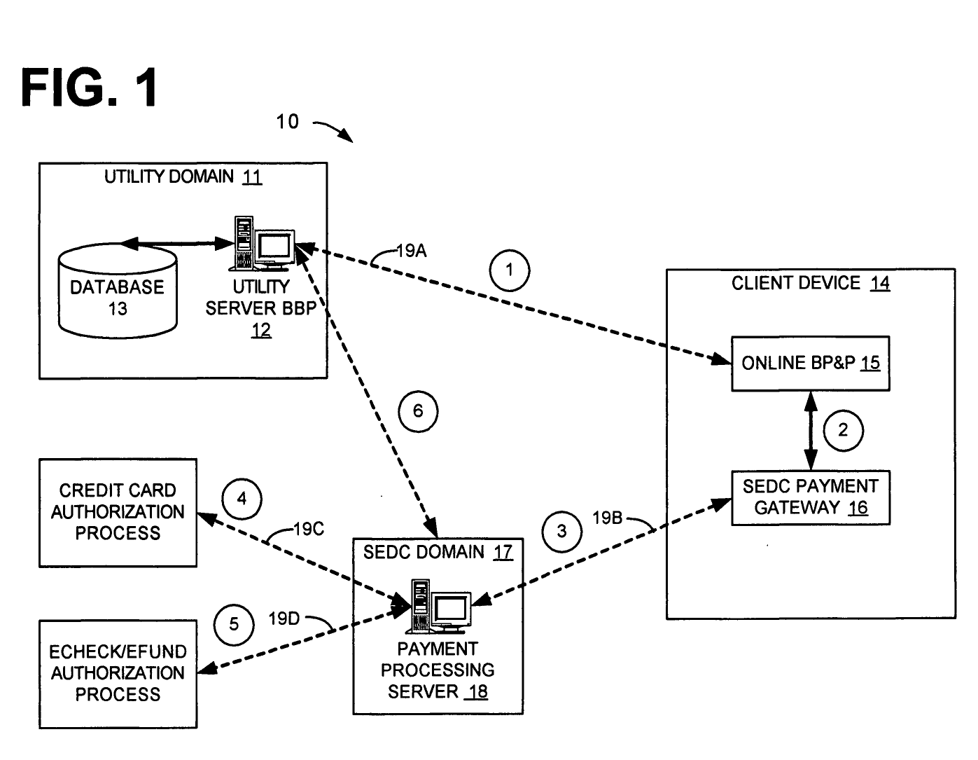

Referring now to the drawings, in which like numerals illustrate like elements throughout the several views, FIG. 1 illustrates an example of the basic components of a system 10 using the third-party payment system used in connection with the preferred embodiment of the present invention. The system 10 includes a server 11, server 17 and the client devices 14 that utilize the third-party payment system of the present invention.

Each remote client device 14 has applications. Server 11 contains applications, and a server database 13 that can be accessed by remote client devices 14 via connections 19(A), respectively, over network. The server 11 runs administrative software for a computer network and controls access to itself and database 13. The remote client devices 14 may access the database 13 over a network, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote client devices 14 may each be located at remote sites. Remote client devices 14 include but are not limited to, PCs, workstations, laptops, handheld computer, pocket PCs, PDAs, pagers, WAP devices, non-WAP devices, cell phones, palm devices, printing devices and the like.

Thus, when a user at one of the remote client devices 14 desires to access the current billing information from the database 13 at the server 11, the remote client device 14 communicates over the network, to access the server 11 and database 13.

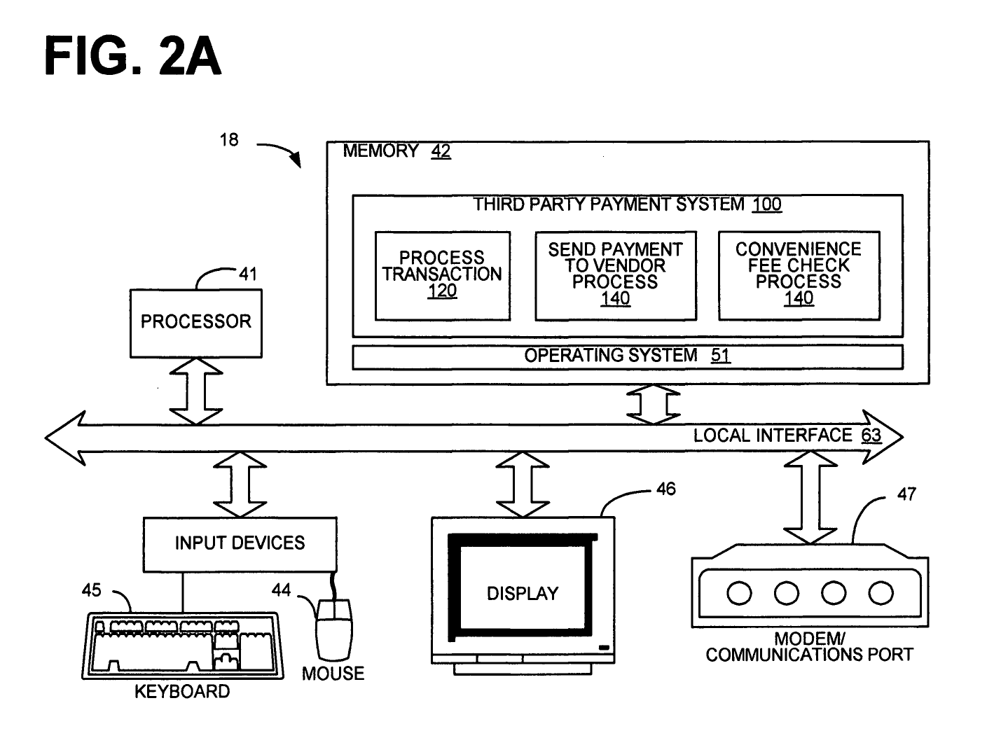

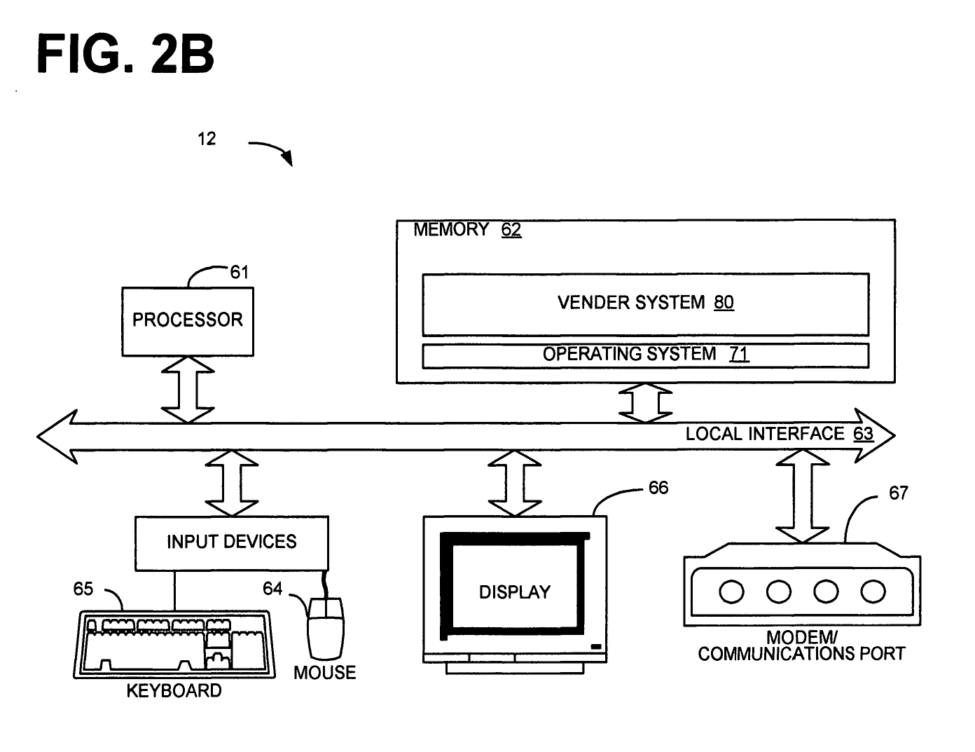

Illustrated in FIG. 2A is a block diagram demonstrating an example of server 17, as shown in FIG. 1, utilizing the third-party payment system 100 of the present invention.

Server 17 includes, but is not limited to, PCs, workstations, laptops, PDAs, palm devices and the like. The processing components of the remote client devices 14 are similar to that of the description for the service computer 11 (FIG. 2).

Generally, in terms of hardware architecture, as shown in FIG. 2, the server 17 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server computer 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 51 and the third-party payment system 100 of the present invention. As illustrated, the third-party payment system 100 of the present invention comprises numerous functional components including, but not limited to, the credit card authorization process 120 and E-check/E-fund authorization process 140.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, such as the third-party payment system 100, and provides scheduling, input-output control, file and data management, memory management, and communication control and related services. However, it is contemplated by the inventors that the third-party payment system 100 of the present invention is applicable on all other commercially available operating systems.

The third-party payment system 100 may be a source program, executable program (object code), script, or any other entity comprising a set of instructions to be performed.

When a source program, then the program is usually translated via a compiler, assembler, interpreter, or the like, which may or may not be included within the memory 42, so as to operate properly in connection with the O/S 51. Furthermore, the third-party payment system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote client devices, other files, devices, systems, or a network), a radio frequency (RF) or other transceiver (not shown), a telephonic interface (not shown), a bridge (not shown), a router (not shown), etc.

If the server 17 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the server 17 is activated.

When the server 17 are in operation, the processor 41 is configured to execute software stored within the memory 42, to communicate data to and from the memory 42, and to generally control operations of the server 17 are pursuant to the software. The third-party payment system 100 and the O/S 51 are read, in whole or in part, by the processor 41, perhaps buffered within the processor 41, and then executed.

When the third-party payment system 100 is implemented in software, as is shown in FIG. 2A, it should be noted that the third-party payment system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The third-party payment system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the third-party payment system 100 is implemented in hardware, the third-party payment system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the vendor server 11 that enables access to the third-party payment system 100 of the present invention, as shown in FIG. 2A. The vendor server 11 provides access to the billing information residing in database 13. The billing information accessed in database 13 can be provided in the number of different forms including but not limited to ASCII data, WEB page data (i.e. HTML), XML or other type of formatted data.

Located in memory 42 of the vendor server 11 is vendor system 80, which includes, but is not limited to, the process transaction data from TPP process 200. The vendor system 80 is he software that a customer or utilizes on a vendors server in order to display information including account and payment information. The process transaction data from TP tea process 200 enables a vendor to update their database. When a customer makes a payment using the third-party payment processor system 100 of the present invention as illustrated in FIG. 2A. When the vendor system 80 is implemented in software, as is shown in FIG. 2B, it can be stored on virtually any computer readable medium for use by or in connection with any computer related system or method.

In an alternative embodiment, where the vendor system 80 is implemented in hardware, the vendor system 80 can be implemented in the same way as described above with regard to the third-party payment system 100 (FIG. 2A). In the example illustrated, it is the vendor system 80 that interacts with the third-party payment system 100 of the present invention. As illustrated, the vendor server 11 includes many of the same components as server 17 described with regard to FIG. 2A.

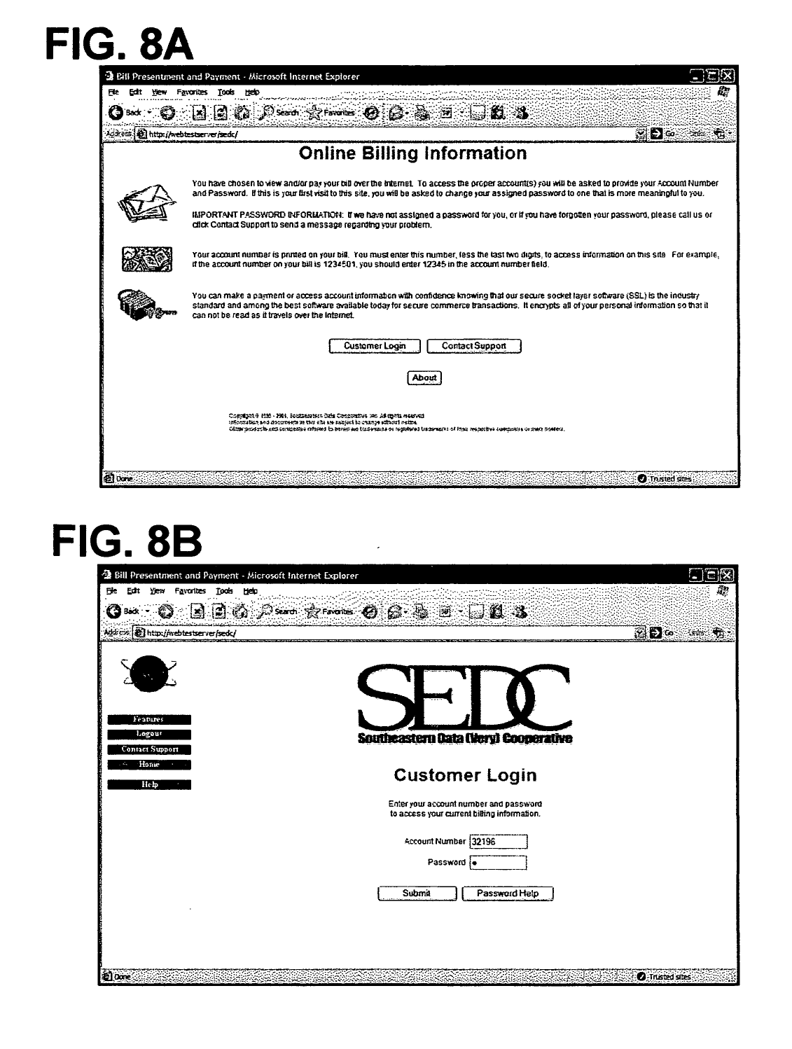

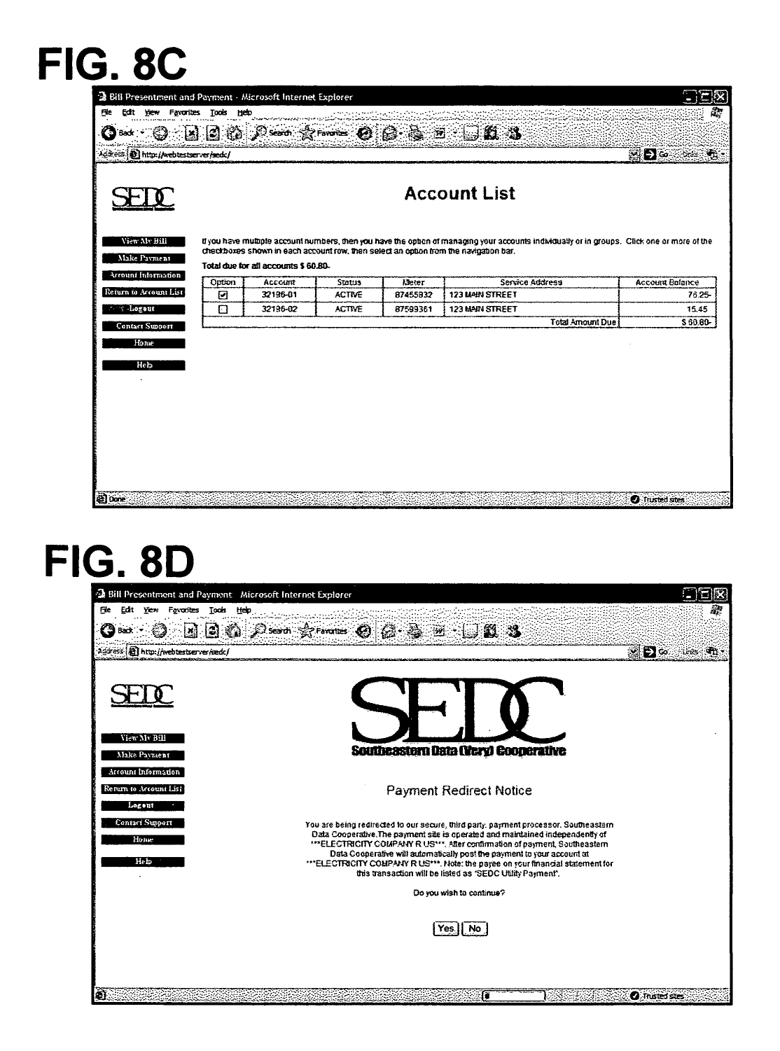

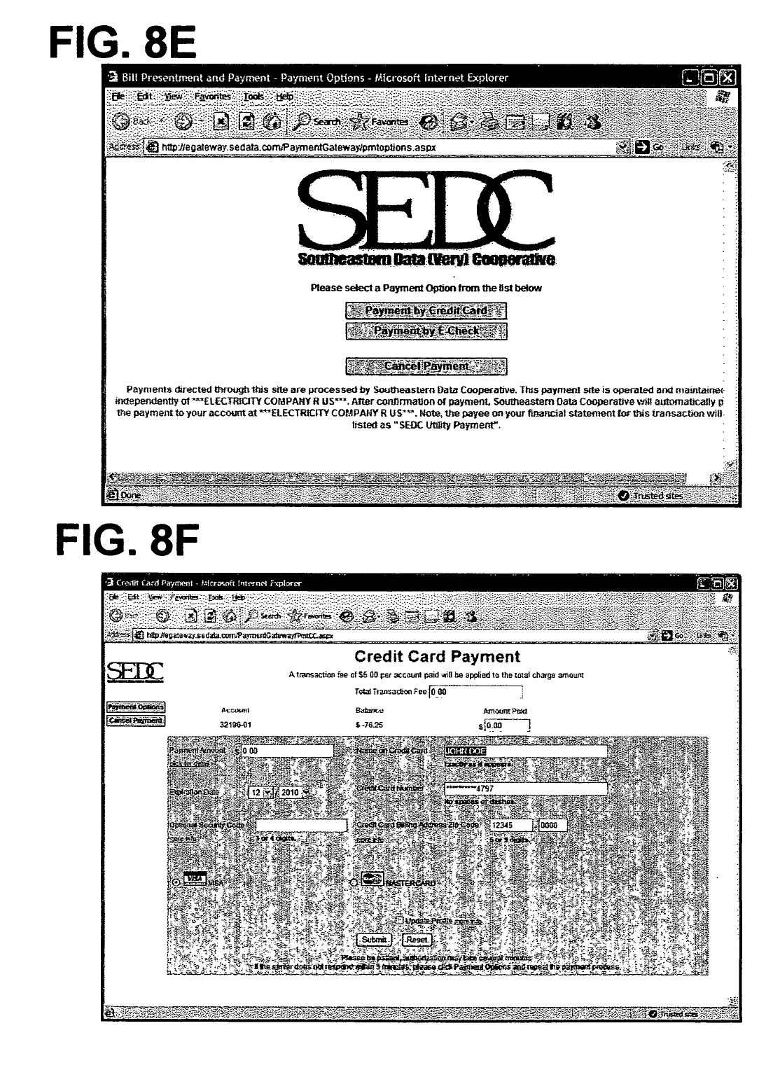

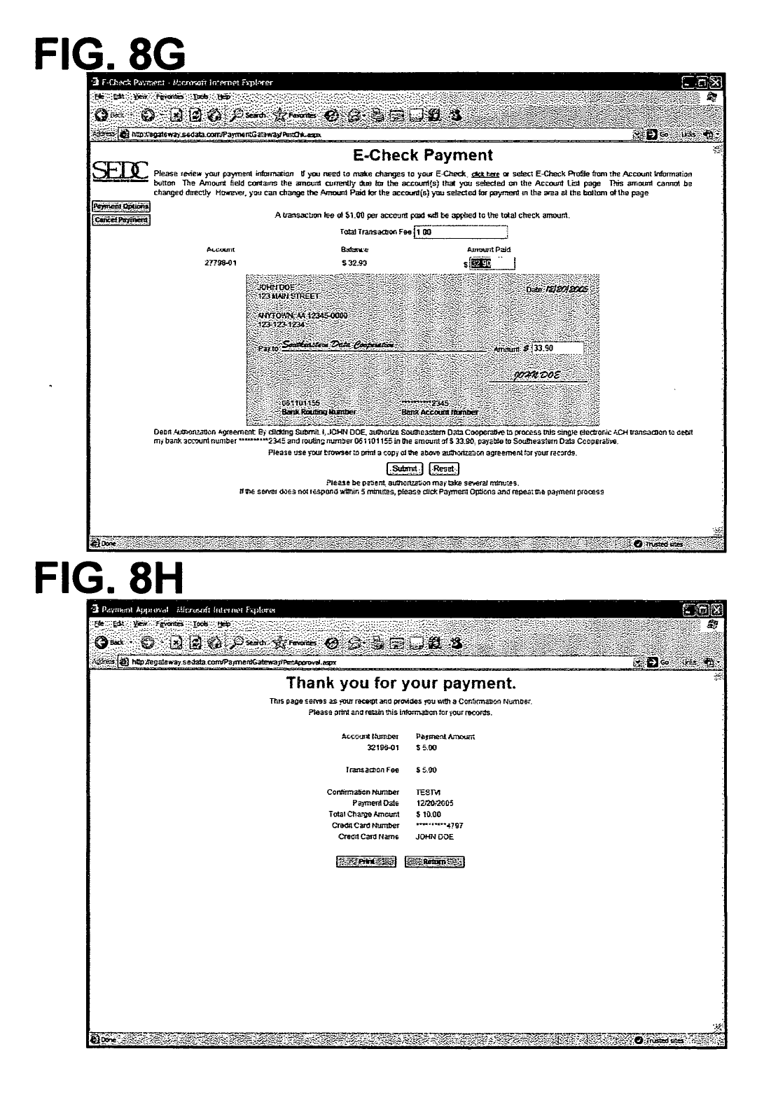

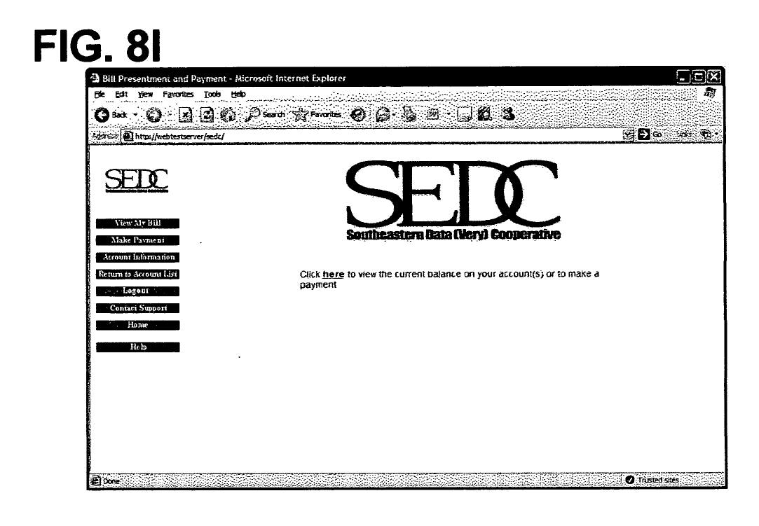

In a more detailed example, utility customer clicks the link from the utility website to access the Online Bill Presentment and Payment application. For example, the Online BP&P is uses SSL (Secure Socket Layer) encryption mechanism over HTTP transmission protocol. When accessed through a browser, it is accessed as an https site.
1. Customer is presented with a login screen hosted by the utility. This screen presents instruction on how to enter the site and notifies the customer it is a secure site (FIG. 8A).
2. After customer clicks on Customer Login, they are presented with the Login screen (FIG. 8B).
3. After a valid login is entered, the customer is presented with the Account List screen displaying all the individual accounts established for the customer number entered in the login screen. If a customer desires to pay an account, they must check the option box coinciding with the account(s) they want to pay (FIG. 8C).
4. Once the customer has selected the account to be paid, he/she selects the Make Payment button on the navigation bar.
5. The customer is presented with the notification they will be redirected to a secure payment site hosted by Southeastern Data Cooperative for 3^{rd} party processing of their payment. If the customer chooses not continue with payment, they are sent back to the Account Select screen for additional options not related to account payment (FIG. 8D).
6. If the customer chooses “Yes” to continue with payment,
   The account selection data is encrypted using industry standard encryption mechanisms, Tripple DES (Data Encryption Standard) and SSL (Secure Socket Layer). The two layer encryption adds additional security layer and protects data being transmitted.
   The encrypted data is posted to a new browser session redirecting the customer to the secure payment site hosted and maintained by SEDC. Note URL
7. Customer is prompted to select a payment option. If “Cancel Payment” is selected, the new browser window is closed (FIG. 8E).
8. If Payment by Credit Card option is selected, the Credit Card Payment screen is displayed. The account(s), balance and amount to be paid automatically are transferred from the utility site and populated on the screen. If a credit card profile exists for the customer on file at the utility database, it is transferred and populates the appropriate fields. If a profile does not exist, the customer enters the necessary information (FIG. 8F).
9. If Payment by E-Check is selected, the E-Check Payment screen is displayed. The account(s), balance and amount to be paid automatically are transferred from the utility site and populated on the screen. If an E-Check profile exists for the customer on file at the utility database, it is transferred at the time of redirect to SEDC and populates the appropriate fields. If a profile does not exist, the customer enters the necessary information (FIG. 8G).
10. After the credit card or eCheck transaction has been approved and a confirmation number received, the payment confirmation screen is presented for the customer (FIG. 8H). Once the customer selects “Return” (FIG. 81)., the dialogue box closes and the customer views the Account List screen again (FIG. 8C).

Described now is a more descriptive process flow of the programs that utilize the dialog boxes described above.

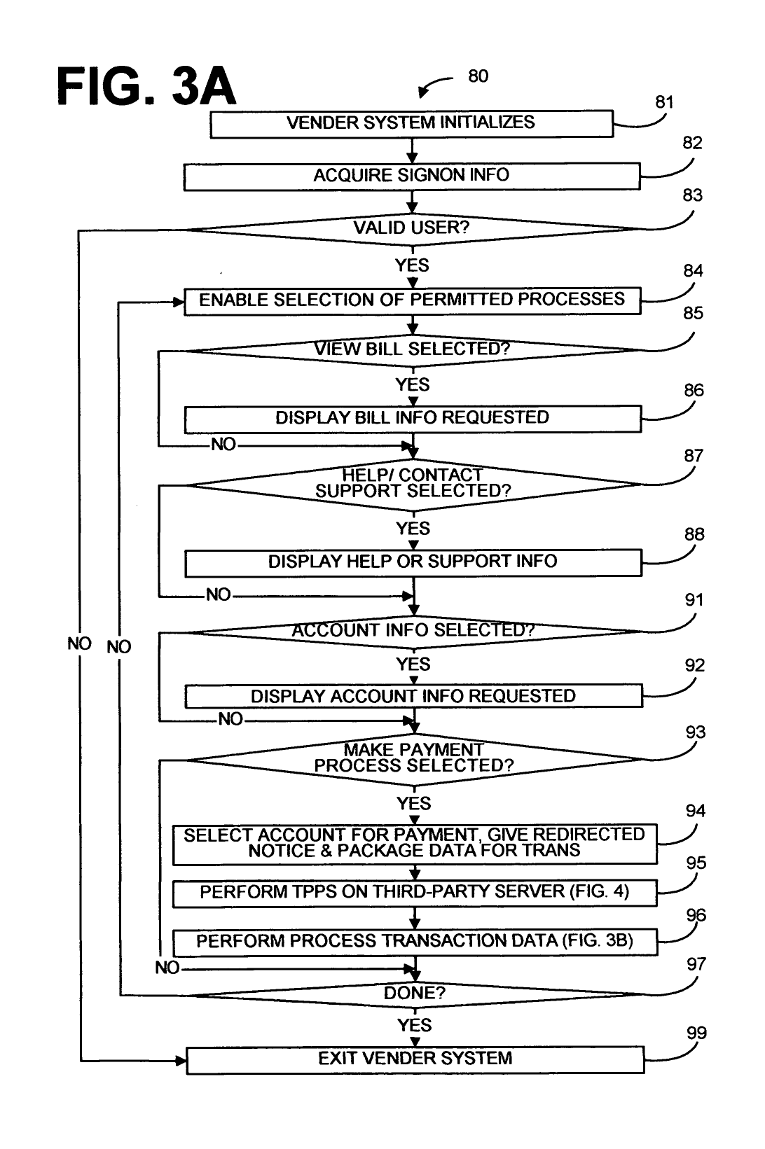

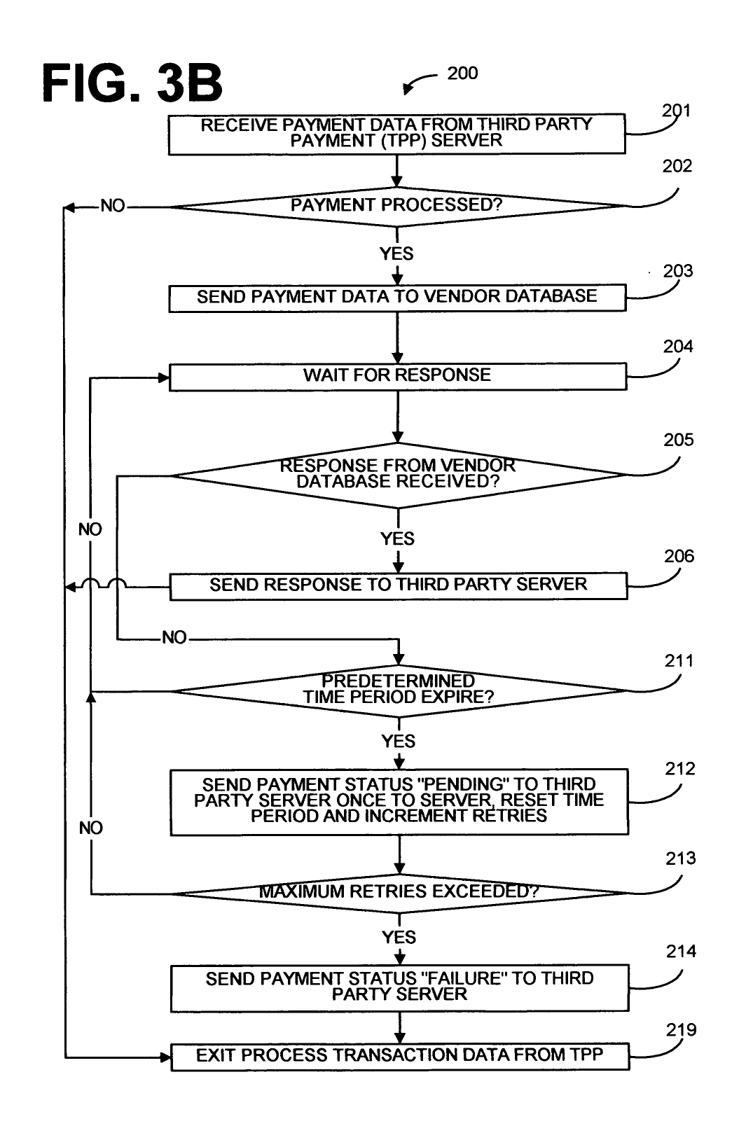

FIG. 3A is a flow chart illustrating an example of the operation of the vendor system 80 on the vendor server 11, as shown in FIGS. 1 and 2B. The vendor system 80 interacts with a customer to enable a customer to display information with regard to any account and to make a payment on any account with that vendor.

First at step 81, the vendor system 80 is initialized. This initialization includes the startup routines and processes embedded in the BIOS of the server 11. The initialization also includes the establishment of data values for particular data structures utilized in the server 11 and vendor system 80. At step 82, the vendor system 80 acquires the customers sign on information. At step 83, the vendor system 80 validates the sign on information. If it is determined that step 83 that the sign on information is invalid, then the vendor system 80 exits at step 99. However, if it is determined that step 83 that the sign on information was valid, then the vendor system 80 enables the customer a selection of permitted processes at step 84.

At step 85, the vendor system 80 determines if the view bill process is selected. If it is determined at step 85 that view bill process is not selected, then the vendor system 80 proceeds to step 87. However, if it is determined that view bill process was selected, then the vendor system 80 displays the bill information requested that step 86.

At step 87, it is determined if the help or contact support option is selected. If the help or contact support option is not selected, then the vendor system 80 proceeds to step 91. However, if it is determined that step 87 that the help or contact support option was selected, then the display of help or support info is performed at step 88.

At step 91, it is determined if the display account info option was selected. If it is determined that the display account info option was not selected, then the vendor system 80 proceeds to step 93. However, if it is determined at step 91 that the display account info option was selected, then the display information is performed at step 92. It should be noted that the inventor's assume that numerous accounts can be displayed for a customer.

At step 93, the vendor system 80 determines if the make payment option was selected. If it is determined is that 93 that the make payment option was not selected, then the vendor system 80 proceeds to step 97. However, if it is determined at step 93 that the make payment option was selected, then the vendor system 80 enables the customer to select the account for payment at step 94. As noted above, there can be numerous accounts for a single customer, as illustrated in FIG. 8C. After selecting the account for payment, the customer receives a direction notice and at proceeds to step 97. Also at step 94, the vendor system 80 packages all the customer and account data for transmission to the third party payment system 100 of the present invention (FIG. 2A). In an alternative embodiment, numerous methods of encryption can be utilized in the packaging of the data for transmission.

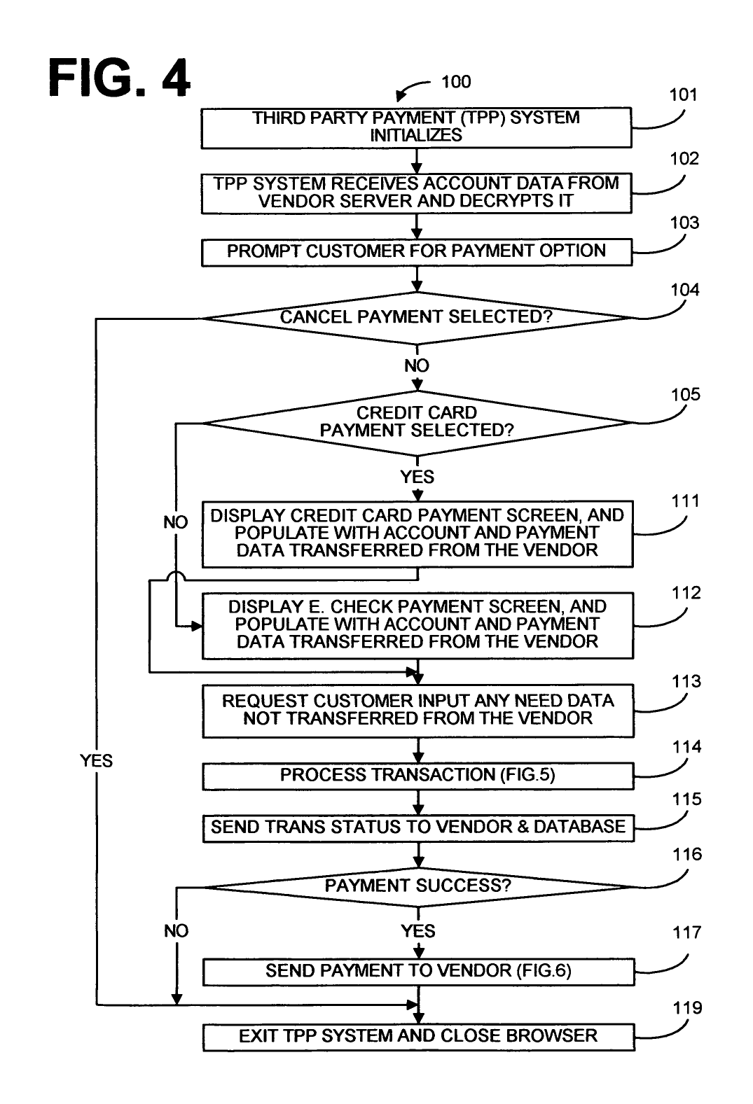

At step 95, the vendor system 80 performs the-third party payment system 100 (FIG. 2A) on a third-party server 17. The third party payment system 100 is herein defined in further detail with regard to FIG. 4. A third party payment system 100 is utilized to process the payment on accounts for a customer.

At step 96, the vendor system 80 performs the process transaction data process herein defined in further detail with regard to FIG. 3. At step 97, the vendor system 80 determines if the customer is done utilizing vendor system. If it is determined that the customer is not done using the vendor system 80, then the vendor system 80 returns to repeat steps 83 through 97. However, it is determined at step 97 that the customer is done utilizing the vendor system 80, then the vendor system 80 exits at step 99.

FIG. 3B is a flow chart illustrating an example of the operation of the process transaction data process 200 in the vendor system 80 on the vendor server 11, as shown in FIGS. 1 and 2B. process transaction data process 200 receives information back from the third party payment server 100 for updating the vendors' database 13.

First at step 201, the process transaction data process 200 receives the payment data from the third party payment system 100 on the server 17 at step 201. At step 202, the process transaction data process 200 determines if a payment is to be processed at step 202. If it is determined at step 202 that the data received from the third party payment system 100 on server 17 and not payment data, then the process transaction data process 200 exits at step 219. However, if it is determined that step 202 that the payment data has been received for processing, then the data is sent to the vendor database 13 at step 203.

At step 204, the process transaction data process 200 waits for a response from the vendor database 13. At step 205, the transit process transaction data process 200 determines if it is received a response from the vendor database 13 after waiting a reasonable time. If it is determined that a response from the vendor database 13 was received its then the process transaction data process 200 sends a response to the third-party system 100 that be payment data has been updated in the database 13. The process transaction data process 200 then proceeds to step 219 and exits.

However, if it is determined at step 205 that no response from the vendor database 13 was received within a reasonable time, then the transit process transaction data process 200 determines if a predetermined time period has expired at step 211. If it is determined that a predetermined time period has not expired at step 211, then the process transaction data process 200 returns to step 204. However, if it is determined that step 211 that the predetermined time period has expired, then be process transaction data process 200 sends a payment status “PENDING” to the third-party system 100 on server 17. If it is determined that the payment pending status has been previously sent to the third-party system 100, then the process transaction data process 200 just resets the time period and increments the retry number at step 212.

At step 213, it is determined if the maximum retry it is exceeded for this transaction. If the determined at step 213 Matt the maximum retry it is not exceeded, then the process transaction data process 200 returns to wait for response at step to a poor.

However, it is determined at step 213 that the maximum retry it has been exceeded, then the process transaction data process 200 sends a payment status of “FAILURE” to the third-party system 100 on server 17 at step 214. The process transaction data process 200 then exited step 219.

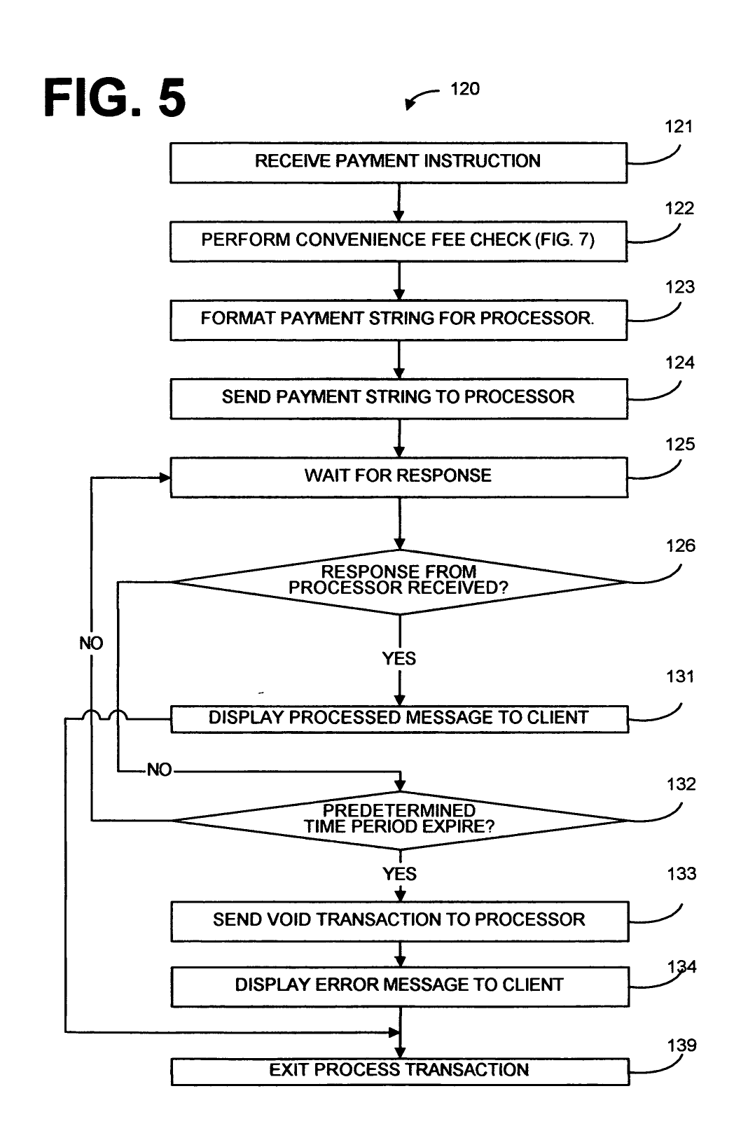

FIG. 4 is a flow chart illustrating an example of the operation of the third-party payment system 100 of the present invention, as shown in FIGS. 1 and 2A. The third party payment system 100 provides vendors with a flexible payment transaction system on a third-party server 17. The third-party payment system 100 includes subcomponent processes, including process transaction process 120, send payment to vendor process 140 and convenience fee check process 160. These processes will be defined in further detail with regard to FIGS. 5, 6 and 7.

First at step 101, the third-party payment system 100 is initialized. This initialization includes the startup routines and processes embedded in the BIOS of the server 17. The initialization also includes the establishment of data values for particular data structures utilized in the server 17 and third-party payment system 100. At step 102, the third-party payment system 100 receives account data from vendor server 11 and decrypts it. As noted before, there are numerous types of encryption/decryption techniques that can be utilized.

At step 103, the customer is prompted for payment option. As illustrated the payment options are by credit card or e-check. However, it should be noted that other types of electronic payment systems may be utilized, such as ATM or check cards. After the customer has indicated the preferred payment option, the third-party payment system 100 determines if the cancel payment option was selected at step 104. If it is determined that the cancel payment option was selected at step 104, then the third-party payment system 100 proceeds to step 119 to close the browser with the customer and exit the third-party payment system 100.

However, if it is determined at step 104 that the cancel payment was option was not selected, then the third-party payment system 100 determines if the credit card payment option was selected at step 105. If it is determined to set one up by the credit card payment option was selected, then the third-party payment system 100 displays the credit card payment screen and populates the screen with the account and payment data transferred from the vendor system 80 at step 111. It should be noted that the third-party payment system 100 may also have customer account and payment data stored on a database for additional input. The third-party payment system 100 then skipped to step 113.

However, if it is determined that step 105 that the credit card payments option was not selected, then the third-party payment system 100 proceeds to step 112. At step 112 the third-party payment system 100 displays the eject payment screen and populates the screen with account and payment data transferred from the vendor. As noted above, the third-party payment system 100 may have access to any database on server 17 that may provide additional account and payment data.

At step 113, the third-party payment system 100 requests customer input of any needed data and not transferred from the vendor or unavailable an AA secure database with on server 17. After acquiring any needed input from the customer at step 113, the third-party system 100 then processes the transaction at step 114. The process transaction process is herein defined in further detail with regard to FIG. 5.

At step 115, the third-party payment system 100 then sends been transaction status to the vendor system 80 and the database on the payment processing server 18. At step 116, the third-party payment system 100 determines that the payment processing was successful. If it is determined at step 116 at the payment process was not successful than the third-party payment system 100 proceeds to step 119 to close the browser open for the customer and exits the third-party payment system 100.

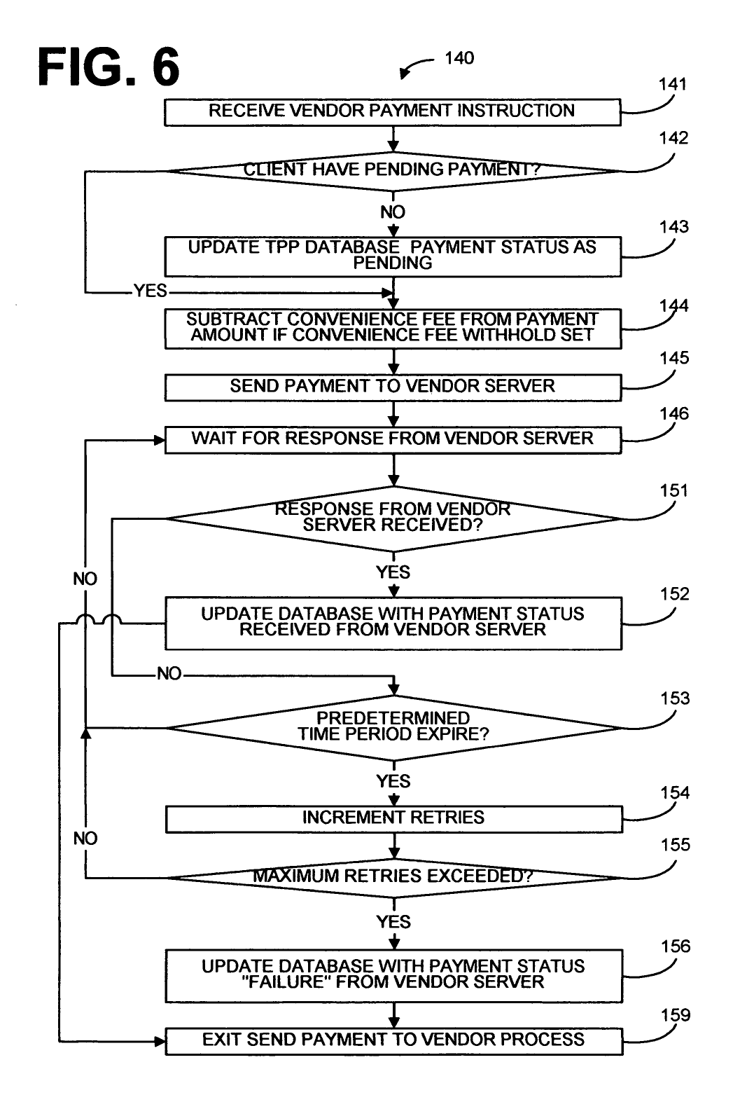

However, it is determined at step 116 at the payment processing was successful, then the third-party payment system 100 sends the sends the payment to the vendor at step 117. The payment is sent to the vendor system 80 utilizing the send payment to vendor process 140 herein defined in further detail with regard to FIG. 6. At step 119, the third-party payment system closes the browser opened for the customer and exits the third-party payment system 100.

FIG. 5 is a flow chart illustrating an example of the operation of the process transaction process 120 utilized by the third-party payment system 100 of the present invention, as shown in FIGS. 2A and 4. The process transaction process 120 is utilized to process the transaction with a credit card or other electronic payment types.

At step 121, the process transaction process 120 receives the payment instructions.

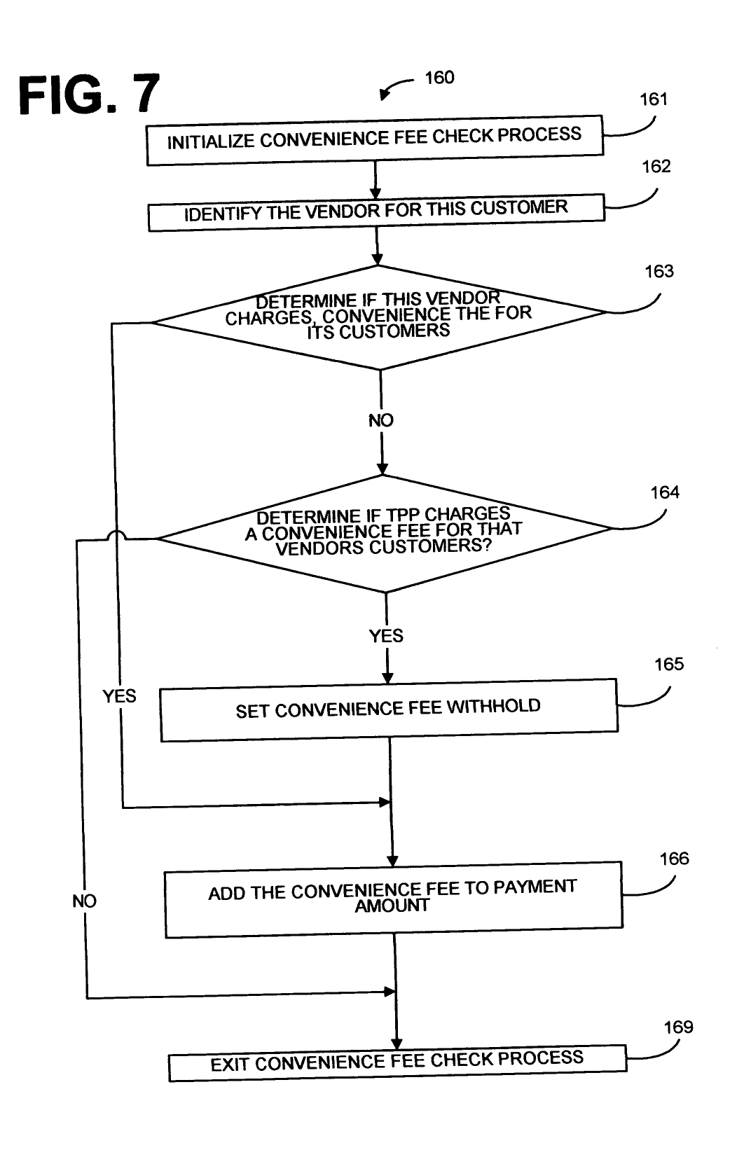

At step 122, the convenience fee check is performed. The convenience fee check process is herein defined in further detail with regard to FIG. 7. The convenience fee check is performed to see whether a convenience fee is to be charged either by the third-party processor or the vendor.

At step 123, the payment data is formatted into a payment string for the processor.

At step 124 this payment stained it is sent to the processor. A number of different types of communication link can be utilized to send the payment string to the processor. These communication links include but are not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks.

At step 125, the process transaction process 120 waits for a response from the processor. After reading a reasonable time process transaction process 120 determines at step 126 if a response from the processor is received. If it is determined at step 126 that a response from the processor was received, then the process transaction process 120 displays a process message to the client or customer and then exits at step 139.

However, if it is determined at step 126 that no response was received from the processor in a reasonable time, then the process transaction process 120 proceeds to step 132 to determine if a predetermined time period has expired. If a predetermined time period has not expired, then the process transaction process 120 returns to wait for a response at step 125. However, if it is determined at step 132 that a predetermined time period has expired, then the process transaction process 120 sends a “VOID” transaction to the processor at step 133 and displays an “ERROR” message to the client or customer at step 134. At step 139, the process transaction process then exits.

FIG. 6 is a flow chart illustrating an example of the operation of the send payment to vendor process 140 utilized by the third-party payment system 100 of the present invention, as shown in FIGS. 2A and 4. The send payment to vendor process 140 interacts with the process transaction data process 200 utilized by the vendor system 82 update the vendor's database to reflect the payment has been made on an account by one of the vendor's customers.

At step 141, the send payment to vendor process 140 receive the vendor payment instruction. At step 142 it is determined if the client has a pending payment. If it is determined that the client does have a pending payment on this account, then the send payment to vendor process 140 skips to step 140. However, if the client does not show that it payment on this account is currently pending, then the send payment to vendor process 140 updates the third-party payment database with a payment status of pending at step 143.

At step 144 is determined if the can been means be with hold flag is set for a payment on this account. It is determined that the convenience fee with hold flag is set at step 144, then they can be subtracted from the payment amount. This is done since the third-party payment system is entitled to a convenience fee for processing this transaction for a customer. The convenience fee will be herein defined in further detail with regard to FIG. 7.

At step 145, payment instructions are set to be vendor system 80 on vendor server 11. At step 146, the send payment to vendor process 140 then waits for a response from the vendor system 80 on the vendor server 11.

At step 151, is determined if a response has from the vendor system 80 on the vendor server 11 has been received within a reasonable time. If it is determined at a response from the vendor system 80 on the vendor server 11 has been received, then the send payment to vendor process 140 updates, the third-party database with the payment status received from the vendor system 80 on the vendor server 11.

However, if it is determined at step 151 that no response has been received from the vendor system 80 on the vendor server 11 within a reasonable time, then it is determined if a predetermined time period has expired at step 153. If it is determined at step 153 that a predetermined time period has not expired, and the send payment to vendor process 140 then returns through step 146 to wait for a response. However, it is determined that the predetermined time period has expired at step 153, then the send payment to vendor process 140 increments the retry count at step 154.

At step 155 determined that the maximum retries has been exceeded. It is the determined at step 155 at the maximum rate tires has not been exceeded, then the send payment to vendor process 140 returns to step 146 to wait for a response from the vendor system 80 on the vendor server 11. However, if it has been determined that the maximum retries has been exceeded, then the send payment to vendor process 140 updates the third-party payment processor database with the payment status of failure from the vendor server at step 156. At step 159, the send payment to vendor process 140 exits.

FIG. 7 is a flow chart illustrating an example of the operation of the convenience fee check process 160 utilized by the third-party payment system 100 of the present invention, as shown in FIGS. 2A and 4-6. The convenience fee check process 160 enables the third-party payment processor system 102 include a convenience fee for processing the payment. The convenience fee is not charged in all transactions, but only if the vendor or third-party processor has the right to charge to the customer the convenience fee.

First the convenience fee check process 160 is initialized at step 161. At step 162, the convenience fee check process identifies the vendor for this customer transaction.

At step 163, it is determined if the vendor charges a convenience fee for its customers. If it is determined that the vendor does charge a convenience fee for its customers, many convenience fee check process 160 proceeds to step 166. However, if it is determined at step 163 that the vendor does not charge a convenience fee for its customers, then the convenience fee check process 160 determines if the third-party processor charges a convenience fee for that vendor's customers. If it is determined at step 164 that the third-party processor does not charge a convenience fee for that vendor's customers, then the convenience fee check process 160 exits at step 169. However, it is determined in step 164 that the third-party processor charges a convenience fee for that vendor's customers banned the convenience fee with hold flag is set at step 165. At step 166 be bad convenient speed to payment amount is performed. The convenience fee check process 160 than exits at step 169.

FIG. 8A-8I are diagrams illustrating examples of the dialog boxes for a customer interacting with the third-party payment system of the present invention.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A method for a third party to process an online transaction of a first party, the method comprising:
receiving an amount of the transaction from a first party;
processing the transaction;
transmitting updated information regarding the transaction from the third-party to the first party and a second party.

2. The method of claim 1, further comprises the step of:
determining if a convenience fee can be charged for processing the transaction; and
adding the convenience fee to the amount of the transaction from the first party.

3. The method of claim 1, further comprises the step of:
determining if a convenience fee can be charged by the second party.

4. The method of claim 1, further comprises the step of:
determining if a convenience fee can be charged by the third party.

5. The method of claim 1, wherein the processing the transaction step further comprises:
determining if a predetermined time period has been exceeded during the processing of the transaction.

6. The method of claim 1, wherein the transmitting updated information step further comprises:
determining if a predetermined time period has been exceeded during the transmitting of updated information to the second party.

7. The method of claim 6, further comprises the step of:
retrying the transmitting of updated information to the second party a predetermined number of times when the predetermined time period has been exceeded.

8. A computer readable medium for a third party to process an online transaction of a first party on a computing device, comprising:
logic for receiving an amount of the transaction from a first party;
logic for processing the transaction; and
logic for transmitting updated information regarding the transaction from the third-party to the first party and a second party.

9. The computer readable medium of claim 8, further comprising:
logic for determining if a convenience fee can be charged for processing the transaction; and
logic for adding the convenience fee to the amount of the transaction from the first party.

10. The computer readable medium of claim 8, further comprising:
logic for determining if a convenience fee can be charged by the second party.

11. The computer readable medium of claim 8, further comprising:
logic for determining if a convenience fee can be charged by the third party.

12. The computer readable medium of claim 8, further comprising:
logic for determining if a predetermined time period has been exceeded during the processing of the transaction.

13. The computer readable medium of claim 8, further comprising:
logic for determining if a predetermined time period has been exceeded during the transmitting of updated information to the second party.

14. The computer readable medium of claim 13, further comprising:
logic for retrying the transmitting of updated information to the second party a predetermined number of times when the predetermined time period has been exceeded.

15. A system for a third party to process an online transaction of a first party on a computing device, comprising:
means for receiving an amount of the transaction from a first party;
means for processing the transaction; and
means for transmitting updated information regarding the transaction from the third-party to the first party and a second party.

16. The system of claim 15, further comprising:
means for determining if a convenience fee can be charged for processing the transaction; and
means for adding the convenience fee to the amount of the transaction from the first party.

17. The system of claim 15, further comprising:
means for determining if a convenience fee can be charged by the second party; and
means for determining if a convenience fee can be charged by the third party.

18. The system of claim 15, further comprising:
means for determining if a predetermined time period has been exceeded during the processing of the transaction

19. The system of claim 15, further comprising:
means for determining if a predetermined time period has been exceeded during the transmitting of updated information to the second party.

20. The system of claim 15, further comprising:
means for retrying the transmitting of updated information to the second party a predetermined number of times when the predetermined time period has been exceeded.
